(19) United States
(12) Patent Application Publication
(10) Pub. No.: US 2004/0075733 A1
(43) Pub. Date: Apr. 22, 2004

(54) Method and apparatus for tempering an optical module

(76) Inventor: Rainer Nebosis, Muenchen (DE)

Correspondence Address: Karl F. Milde, Jr., Esq., MILDE & HOFFBERG, L.L.P., Suite 460, 10 Bank Street, White Plains, NY, 10606, US

(21) Appl. No.: 10/655,687

(22) Filed: Sep. 5, 2003

(30) Foreign Application Priority Data
Sep. 6, 2002 (EP) 02020046.5

(51) Int. Cl. B41J 15/14; B41J 27/00

(52) U.S. Cl. 347/261; 347/243

(57) ABSTRACT

A passive, stable optical system whose temperature is actively regulated is best suited to prevent color fringes in high-speed recorders for digital color images. Peltier elements (14) are well suited as actuators for active temperature regulation. They allow for temperature stabilization of both rapid heating and cooling of the components and housing (10) of an optical module (1) of a high-speed recorder. The overall design of the module (1) must be adapted for each individual application of the Peltier elements (14).

The invention relates to an optical module for exposing an image receptor element, such as photographic paper, and a process for operating an optical module.

Optical modules are used, for example, for digital exposure of photographic paper. For this, three laser beams are scanned at high speed over the photographic paper, and the paper is moved forward perpendicular to the direction of scan. The photographic paper is thus exposed using three colors, e.g., red, green and blue. The image information is reproduced by means of the rapid modulation of the light beams during the scan.

FIG. 1 shows one example of components of such a type of optical module 1 in a perspective view. A red laser 2, a green laser 3, and a blue laser 4 are provided as light sources. An acousto-optical modulator (AOM) 5, 6, and 7 follows each laser for beam formation along with mirrors and lenses based on piezo-electric principles. Each modulator 5, 6, 7 serves to provide continuous modulation of the light output in individual color channels. Subsequently, the three beams are superimposed and then deflected by means of a rotating mirror wheel (polygon scanner) 8. A subsequent lens 9 focuses the laser beams onto the image plane.

Optical modules of this type are formed in high-performance exposure systems that are used, for example, to expose photographic paper in large-scale photo-finishing laboratories. In order to expose the 20,000 images per hour, the exposure speed must be very high. Because of this very high exposure speed, the polygon scanner 8 must be operated at very high speeds (30,000 to 40,00 rpm). Based on the motor output and the air resistance of the polygonal mirror, considerable waste heat builds up in the module 1.

The three laser beams must be exactly superimposed in order to prevent distortion, for example in black text or black edges. In the left half of FIG. 2, an image is shown in which the superimposition of the laser beams is of poor quality. The unfocused image appearing in this photograph has distorting color fringing, particularly at the edges. Next to it, the image in the right half of FIG. 2 was created using exact superimposition of the laser beams. No color fringing is detectable even at the edges.

Color superimposition along the fast-scan direction FS as shown in FIG. 1 is performed electronically. In the direction perpendicular to it (slow-scan), the color superimposition is achieved by optical superimposition of the laser beams. To prevent color fringes from occurring during operation, the position of the beams in the individual color channels must not change with respect to one another. This means that alteration of the beam position is not permissible either along the slow- or fast-scan direction. For this, it is necessary to provide for long-term stablity that guarantees a relative color separation on the photographic paper of less than 10 μm between all three colors. Also, the module 1 must be insensitive to variations in ambient air temperature throughout a range of from 15° C. to 35° C.

The stability of the color superimposition is determined by various component and environmental conditions. Among other things, these include:

(1) Stability of the laser itself;

(2) Stability of the optical components;

(3) Mechanical stability of the cast-aluminum body of the optical module; and

(4) Ambient air temperature and the temperature of the optical module.

Various components of the optical module 1, particularly the green and the blue lasers 3, 4 possess a maximum-allowable operating temperature. If this temperature is exceeded, then its error-free function is no longer ensured. For lasers used in the optical modules, this temperature is typically 40° C.

The polygonal mirror infuses about 50 W to 70 W of heat into the module 1 at speeds greater than 30,000 rpm, depending on its design. If uncooled, it would soon rise to above 50° C.

A heat resistance of 0.07 K/W must be realized using air-cooling and corresponding cooling devices in order to prevent warming above 40° C. This value may be realized only by forced-air ventilation using high-performance devices, but not for an optical module.

A typical specification for laser stability in air-cooled systems might be: pointing stability=4 μrad per ° C.; position stability=1 μm per ° C. at beam width of 100 μm. FIG. 3 clarifies the so-called pointing stability and position stability. The pointing stability is related to angular displacement of the laser beam that results from an alteration of the laser temperature. Contrastingly, the position stability is described by a parallel displacement of the laser beam resulting from temperature deviations.

For example, with a change of ambient air temperature of 20° C. at this typical specification, an angular deviation of 80 μrad and a parallel deviation of 20 μm would result if no tempering were provided. This would lead to a color error of about 60 μm in the overall system if the blue laser were to drift downward and the green laser were to drift upward. This unacceptable instability in the beam occurs even when parts of the laser are maintained internally at a constant temperature. The cause for this is the thermal expansion of brackets that are not tempered, for example.

Air-cooling of the polygonal mirror 8 alone or of the optical module 1 is therefore not adequate. At lower rpm's, however, air-cooling represents an alternative to other cooling methods.

A further problem with air-cooling consists in the fact that the lens 9 may be contaminated by agitated paper dust carried along with the airflow to the module. Such paper dust arises during transport, stamping, and cutting of the paper during the photo-finishing process. In total, it may be established that cooling of the module 1 with pre-cooled air represents a relatively high expense and delivers inaccurate tempering of the module 1.

Such an air-cooled optical module is known from the Japanese patent application with the publication number JP-A-2000206627. The exposure device described therein possesses cooling fins on its underside oriented in various directions. The fins are supplied with cool air from a blower.

A significantly higher degree of cooling than with air-cooling may be achieved when cooling using a liquid coolant that is cooled by an external device (heat exchanger). The cast body of the optical module must be of double-wall design for this, or must be provided with heat exchange tubes, similar to a refrigerator cooling element.

Because of good thermodynamic contact of the coolant with the optical module and of the large heat capacity of the coolant, a module temperature may be adjusted that is less dependent upon ambient air temperature than is the case for air cooling.

Also, contamination by dust is avoided by this type of cooling. The technical degree of complexity of liquid cooling for an optical module is extremely high, however, and its implementation is very expensive. Active control of the module temperature may be achieved only by means of coolant flow regulation. Also, warming of the module is not possible using this technique. This means that it may take a long time after the device is switched on before the entire module achieves thermal stability.

A similar liquid-cooled optical module is described in the Japanese patent application with publication number JP-A-08122683. The double-walled mantle surrounding the optical module is filled with coolant. This coolant is circulated between the walls, and an external cooler provides the cooling required.

### SUMMARY OF THE INVENTION

A principal object of the present invention is to provide an optical module, and a process for operating an optical module, which provides, on the one hand, efficient cooling of the optical module components, and on the other, rapid thermal stabilization.

This object, as well as other objects which may become apparent from the discussion that follows, are achieved by providing an optical module for exposing an image reproduction element with at least one light source device to be heated and/or cooled, at least one beam formation device to be heated and/or cooled that is in optical contact with the at least one light source device, and a heat transfer device in thermal transport connection with the at least one light source device and the at least one beam formation device. According to the invention, the heat transfer device includes a heat-pump.

Moreover, the above-mentioned object is achieved by providing an optical module for exposing an image reproduction element which possesses a heat-conductive housing, at least one optical device to be heated and/or cooled that is positioned within and thermally coupled to the housing; and a heat transfer device thermally coupled to the housing, through which the at least one optical device may be directly or indirectly cooled by the housing. According to the invention, the heat transfer device includes a heat pump.

Further, the present invention provides a method for operating an optical module having at least one light-source device to be heated and/or cooled, and at least one beam-formation device to be heated and/or cooled and which is in optical contact with the at least one light-source device, for exposing an image reproduction element. In this method heat is transferred to or from both the at least one light source device and the at least one beam-formation device. According to the invention, this heat transfer is actively supported by a heat pump.

Finally, the present invention provides a method for operating an optical module with a thermally-conducting housing and at least one optical device to be heated and/or cooled, that is positioned within, and in thermal transport connection with, the housing, for the purpose of exposing an image reproduction element. In this method, heat is transferred to or from the housing so that at least one optical device above the housing is heated or cooled indirectly. According to the invention, the heat transfer is directly supported by means of a heat pump.

The heat pump preferably operates in accordance with a thermo-electric principle. The heat pump preferably includes one or more Peltier elements. This makes it possible under electric control to pass heat to, or away from, the desired components of the optical module.

A heat conductive coupling may exist between the devices to be cooled or heated and the heat pump. This makes it possible to heat and/or cool several components of the optical module using a single heat pump.

The heat transfer device preferably includes a regulating device to regulate the temperature of the device to be cooled and/or heated. This should ensure that the components of the optical module might be kept at a constant temperature from the beginning of the operation.

The components of the heat pump device should be so distributed within the optical module that isothermal regions may be created within it. Sensitive devices of the optical module may then be mounted in these isothermal regions so that they do not react among themselves to variations in ambient temperature.

Each of the at least one light-source devices may include a laser, and particularly a laser diode. Additionally, the above-mentioned beam-formation device with simple mirror and lenses may also include a polygonal mirror to scan an image reproduction element such as photographic paper. Very high sampling speeds may be achieved with this polygonal mirror.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a perspective view showing the positioning of the optical components in an optical module according to the state of the art.

FIG. 2 is a comparative representation of images with good and bad beam superimposition.

FIGS. 3A and 3B are representational diagrams of two different potential beam instabilities.

FIGS. 4A and 4B are a perspective view and a schematic side view, respectively, of an optical module according to the invention.

FIG. 5A is a diagram of thermal distribution within an optical module and FIG. 5B is a top view of an optical module.

FIG. 6 is a block diagram of a control unit for controlling the operation of Peltier elements in dependence upon the sensed temperature.

### DESCRIPTION OF THE PREFERRED EMBODIMENTS

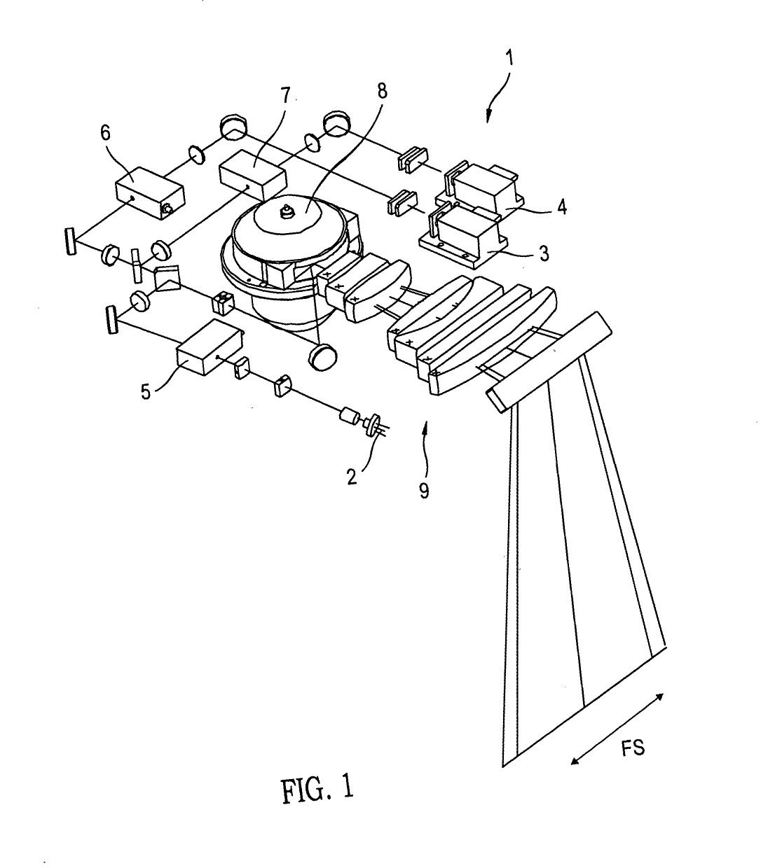

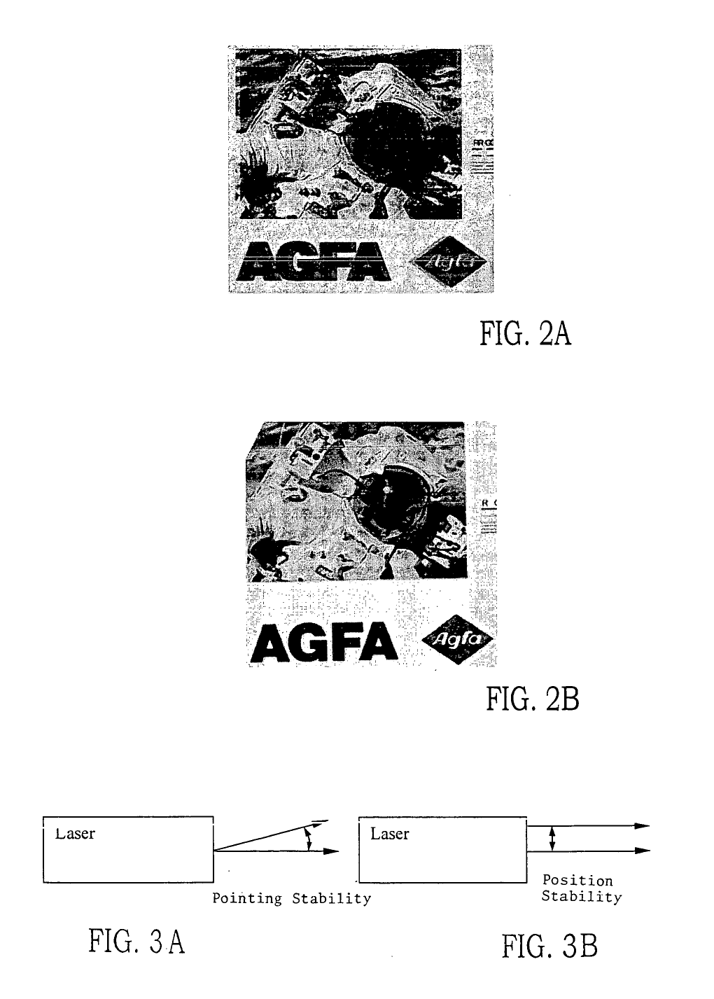

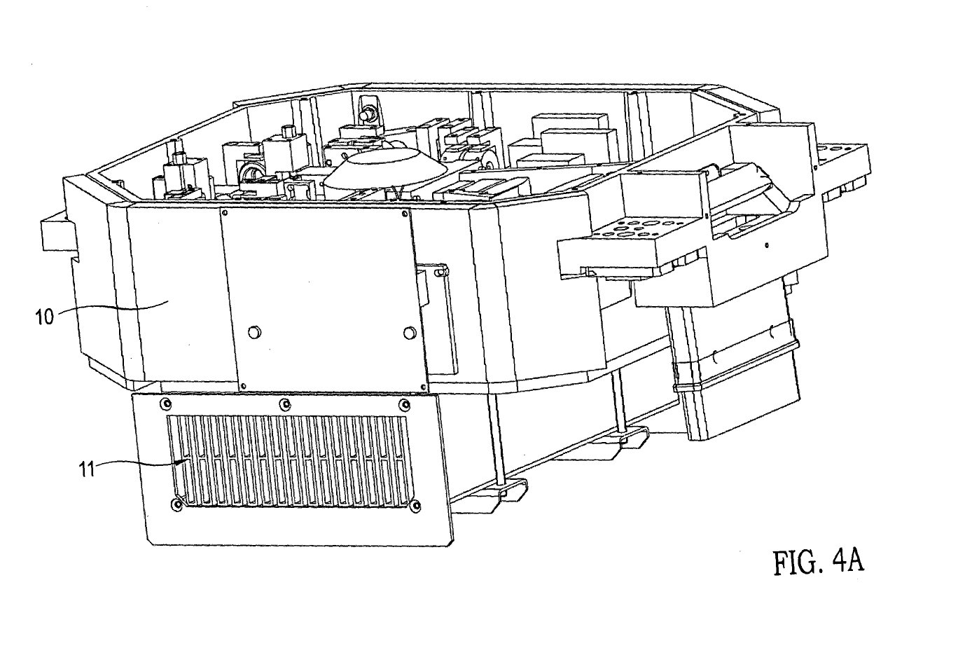

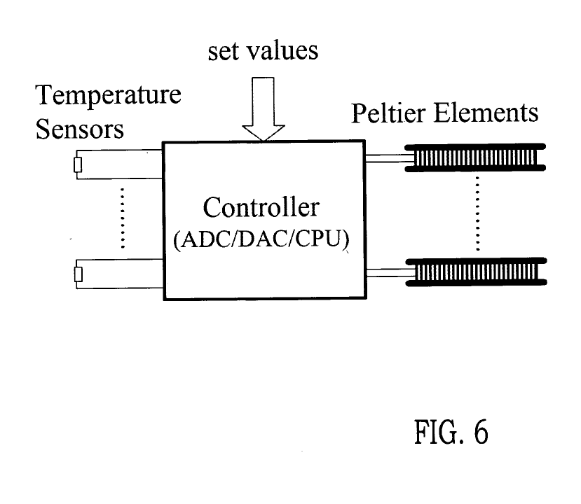

The preferred embodiments of the present invention will now be described with reference to FIGS. 1-6 of the drawings. Identical elements in the various figures are designated with the same reference numerals.

The embodiment described below represents a preferred embodiment of this invention. During cooling with Peltier elements, also referred to as Thermo-Electric Coolers (TECs), active regulation of the temperature of the optical module may be achieved. This takes advantage of the fact that a TEC may both heat and cool. Depending on the polarity of the current flowing through the TEC, one side of the TEC warms and the other cools, and vice versa. One or several temperature sensors register the current module temperature, and serve as the actual value of a regulation circuit that provides flow to the TEC. Thus, when the device is switched on, a stable thermal condition is achieved very rapidly, and this condition is maintained during changing ambient conditions.

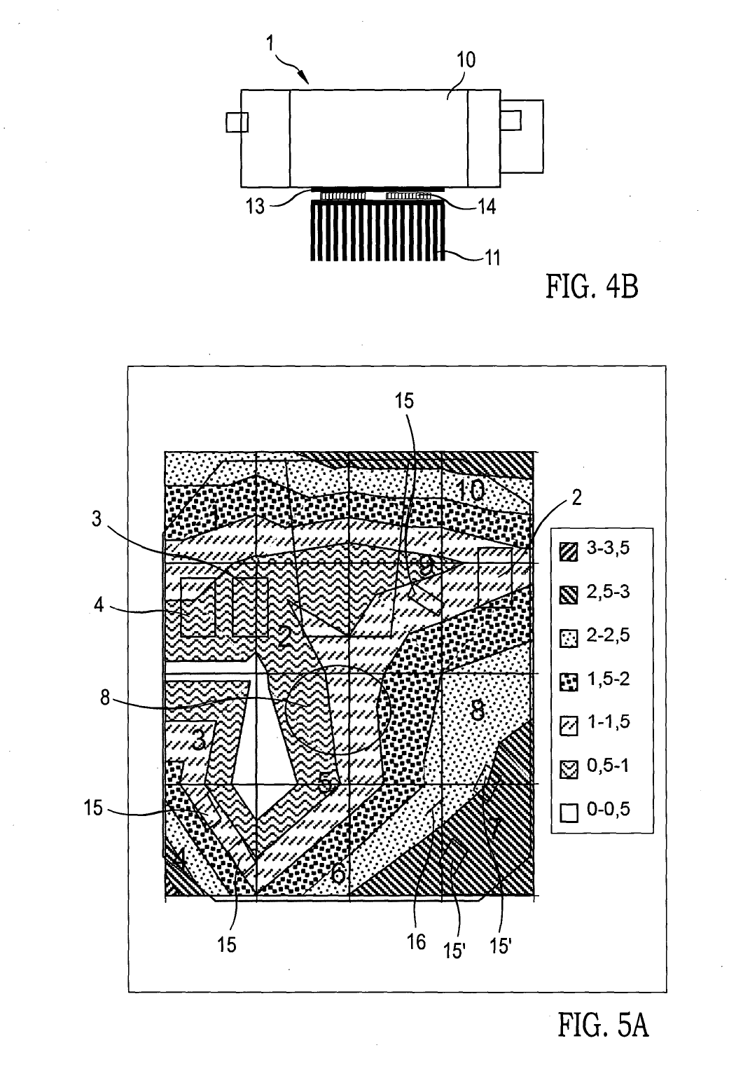

FIG. 4A shows an optical module according to the invention. The individual-optical components are mounted within a cast-aluminum housing 10. The cover of the housing 10 is removed in this view. A cooling body 11 may be seen below the housing 10. It is in thermodynamic contact with ambient or cooling air.

FIG. 4B illustrates a side view of the optical module 1 of FIG. 4A. On the underside of the housing 10 is located a tempered plate 13, and below it is the cooling body 11. One or more TEC's, or one or more Peltier elements 14 are located between the cooling body 11 and the tempered plate 13. Good thermodynamic contact exists between the housing 10, the tempered plate 13, the Peltier elements 14, and the cooling body 11. The TEC's may be operated electrically in series, in parallel, or individually in a controlled manner.

Significant for functionality are not only the achievement of a constant temperature, but also the homogeneity of the temperature within the module. For this, two different operating modes must be considered:

(1) Low ambient or device temperature, e.g., 20° C.: The TEC's must heat in order to achieve the desired operating temperature.

(2) High ambient or device temperature, e.g., 40° C.: The TEC's must cool in order to achieve the desired operating temperature.

During a temperature variation of, for example, from 20° C. to 40° C., differing temperature gradients arise within the optical module. This can lead to the condition in which individual optical components in optical module 1 experience different individual temperature alterations during variation of the ambient temperature. This has the result that the component temperatures diverge from one another, and corresponding color fringes occur. These color fringes may mostly be prevented by positioning the most sensitive components on an isothermal surface within the optical module. In order to achieve this, the heat sources and heat sinks must be positioned accordingly within the optical module. An arrangement must result in which the most sensitive components are positioned about the heat source, and the TEC's must be positioned with suitable symmetry. If only one temperature sensor is deployed, it must be in the area of this isothermal surface.

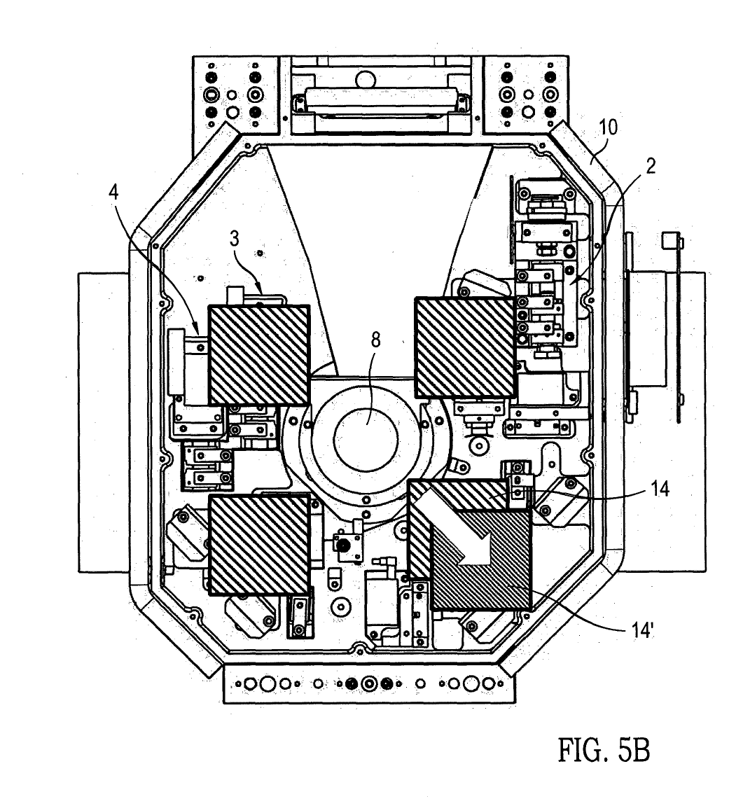

FIG. 5A shows temperature progressions as adjusted during a variation of ambient temperature from 20° C. to 40° C. within the optical module. The brighter the areas, the less the temperature changes under the prescribed temperature regulation. This temperature progression diagram shows the position of the lasers 2, 3, 4, the polygonal mirror 8, and the most important ones of the mirrors 15. One may see from the illustration that the lasers 2, 3, 4, and most of the mirrors 15 are positioned closely together on isotherms. The positioning of the TEC's is shown in FIG. 5B, which is a top view of the housing floor of the optical module 1. They are positioned symmetrically about the polygonal mirror 8.

From FIG. 5A it may be seen that a so-called beam-combiner 16 and additional mirrors 15′ are not positioned together with the other optical components on an isothermal surface. This requires that the light gray areas in the graphic be expanded downward and to the right to the point that the beam-combiner 16 and the mirrors 15′ also rest upon an isothermal surface. This may be achieved by displacing the lower right TEC 14 to the position 14′. Thus, the lateral thermal conductivity of the module may better be taken into account.

The advantages of active cooling are that the lasers in this case, during an ambient temperature variation of 20° C., will be heated or cooled by only about 1° C. Thus, the color fringing caused by the laser is not 60 μm, but rather merely 3 μm. Additionally, it is ensured that each component will operate well below its critical temperature.

In addition to the lasers 2, 3, 4, other components such as the beam-combiner 16 and cylindrical lens holders or mirrors 15 are also sensitive to temperature variations. Thermal expansion of these components leads to distortions that influence beam superimposition, so that color fringing may result. A homogenous module temperature is thus not only advantageous for the lasers, but also increases the stability of the entire system.

Use of TEC cooling generates large temperature gradients in general. In order to prevent this, both the cast body 10 and the optical system should fulfill the following conditions:

(1) The lateral thermal conductivity of the cast body or of the housing 10 should be of a high value and be symmetrically distributed. This is achieved using suitable heat-conduction fins inside and outside the housing that also provide increased mechanical stiffness.

(2) The optical system should be positioned symmetrically about the heat source(s).

(3) Positioning of the TEC's should make allowance for the symmetry of the actual thermo-conductivity.

Several temperature regulation temperature sensors may be distributed within the optical module. These sensors are preferably positioned in the vicinity of the cooling elements since, because of the sluggish reaction of these elements, the most indicative temperature measurements may be determined here. If, however, the most significant optical components are located on isothermal surfaces, the use of a single temperature sensor positioned on a suitable isothermal surface is sufficient.

The cooling or heating of the optical module by means of thermal conduction from and to the Peltier elements may also be augmented by means of other thermal transfer mechanisms. Thus, for example, additional heating or cooling means using convection may be positioned in the interior of the optical module. Additional tempering of the optical module by means of radiant heat is also possible.

In the embodiment described above, tempering may be managed more or less centrally via the optical module housing. It is alternatively also conceivable to provide individual tempering of groups of several optical components of the optical module in that the particular component group is heated or cooled by means of Peltier elements.

There has thus been shown and described a novel method and apparatus for tempering an optical module which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In an optical module for exposing an image reproduction element comprising:
(1) at least one light source device;
(2) at least one beam forming device optically coupled with said at least one light source device for providing at least one optical beam; and
(3) a heat transfer device thermally coupled with said at least one light source device and said at least one beam forming device;
the improvement wherein the heat transfer device comprises a heat pump.

2. Optical module as recited in claim 1, wherein the heat pump operates according to a thermo-electric principle.

3. Optical module as recited in claim 2, wherein the heat pump comprises at least one Peltier element.

4. Optical module as recited in claim 1, comprising a heat conductive coupling between the heat pump and the device to be heated or cooled.

5. Optical module as recited in claim 1, wherein the heat transfer device includes a regulating device for regulating the temperature of the device to be heated or cooled.

6. Optical module as recited in claim 1, wherein components of the heat pump are so distributed throughout the optical module that isothermal areas are realized within the optical module.

7. Optical module as recited in claim 1, wherein each of said at least one light source device includes its own laser.

8. Optical module as recited in claim 1, wherein the beam-formation device includes a polygonal mirror.

9. In an optical module for exposing an image reproduction element, comprising:
(1) a thermally conductive housing;
(2) at least one optical device, capable of being heated and cooled, positioned within, and thermally coupled to said housing; and
(3) a heat transfer device thermally coupled to said housing, whereby said at least one optical device may be indirectly heated or cooled via the housing;
the improvement wherein the heat transfer device comprises a heat pump.

10. Optical module as recited in claim 9, wherein the heat pump operates according to a thermo-electric principle.

11. Optical module as recited in claim 10, wherein the heat pump comprises at least one Peltier element.

12. Optical module as recited in claim 9, comprising a heat conductive coupling between the heat pump and the device to be heated or cooled.

13. Optical module as recited in claim 9, wherein the heat transfer device includes a regulating device for regulating the temperature of the device to be heated or cooled.

14. Optical module as recited in claim 9, wherein components of the heat pump are so distributed throughout the optical module that isothermal areas are realized within the optical module.

15. A method for operating an optical module having at least one light source device capable of being heated and cooled, and at least one beam forming device capable of being heated and cooled, in optical contact with the at least one light source device, for exposing an image reproduction element, including the step of jointly transferring heat toward or away from said at least one light source device and said at least one beam forming device, the improvement wherein the said heat transferring step is actively supported by a heat pump.

16. Method as recited in claim 15, wherein the heat pump device operates according to a thermo-electric principle.

17. Method as recited in claim 15, wherein the device to be heated or cooled is temporally regulated to a substantially constant temperature.

18. Method as recited in claim 15, wherein areas of the optical module are maintained isothermally.

19. A method for operating an optical module having a thermally conductive housing and at least one optical device to be heated or cooled, positioned within and thermally coupled to the housing, for exposing an image reproduction element including the step of transferring heat to the housing or away from it so that said at least one optical device is indirectly heated or cooled by the housing,
wherein said heat transferring step is actively supported by a heat pump.

20. Method as recited in claim 19, wherein the heat pump device operates according to a thermo-electric principle.

21. Method as recited in claim 19, wherein the device to be heated or cooled is temporally regulated to a substantially constant temperature.

22. Method as recited in claim 19, wherein areas of the optical module are maintained isothermally.
